(19) United States
(12) Patent Application Publication
(10) Pub. No.: US 2026/0216931 A1
(43) Pub. Date: Jul. 30, 2026

(54) INJECTION-MOLDED DISPOSABLE PLASTIC ITEM, PRODUCTION AND USE THEREOF

(71) Applicant: Eppendorf SE, Hamburg (DE)

(72) Inventor: Christian TAESLER, Hamburg (DE)

(73) Assignee: Eppendorf SE, Hamburg (DE)

(21) Appl. No.: 19/147,225

(22) PCT Filed: Sep. 6, 2023
(86) PCT No.: PCT/EP2023/074514

§ 371 Date: Jul. 10, 2025

(51) Int. Cl. B29C 45/00; B29C 45/26; B29K 23/00; B29K 25/00; C08L 23/06

(52) U.S. Cl. CPC B29C 45/0001; B29C 45/26; C08L 23/06; B29K 2023/0633; B29K 2025/08; B29K 2995/0026; B29K 2995/0029; C08L 2207/066

(57) ABSTRACT

The invention relates to an injection-molded disposable plastic item consisting of the two plastics low-density polyethylene (LDPE) and cyclic block copolymer (CBC), wherein 95-30% by weight of LDPE and 5-70% by weight of CBC are present, the injection-molded disposable plastic item is translucent or transparent, has a melt flow index MFR (190° C./2.16 kg) in the range from 0.1 to 2.5 g/10 min according to ISO 1133 and contains no additives. The invention also relates to its manufacture and its use, for example as a container, pipette or pipette tip. Due to its composition, the injection-molded disposable plastic item has the special feature that components that can be leached out of it by solvents are reduced to a minimum, except for an unavoidable proportion. This almost completely prevents contamination of stored liquid ingredients contained in the injection-molded disposable plastic item.

### CROSS-REFERENCE TO RELATED APPLICATIONS

This application is a national stage of International Application No. PCT/EP2023/074514 filed on Sep. 6, 2023, which is hereby incorporated by reference herein.

### TECHNICAL FIELD OF THE INVENTION

The invention relates to an injection-molded disposable plastic item, a method for its production and its use.

### BACKGROUND OF THE INVENTION

It is known that plastic items have the disadvantage that components can leach out of the plastic material in contact with a liquid medium, especially liquid samples, and thus contaminate the liquid medium or the sample. These are, for example, plastic additives contained in the plastic that support the thermal processability, such as antioxidants. These leachable components or contaminants, also known as “leachables”, then become part of the content of the plastic item and adulterate or contaminate it. This has a particularly detrimental effect if tests are to be carried out with samples in the plastic items, such as chemical or biological assays, wherein these contaminants can interfere with or even inhibit the tests. These contaminations have a particularly serious effect on small volumes.

Plastic items are generally used in a variety of applications, for example also in applications in the field of life sciences, i.e. in areas or research fields that deal with living beings, their structures and processes. These are, for example, the fields of medicine, pharmacology, biochemistry, biotechnology, in particular cell biology, microbiology or molecular biology. Plastic items used in these fields are made from polyolefins, for example, which generally contain plastic additives or fragments that are then leached out by the solvents normally used in these fields, such as polar protic or aprotic solvents. This contaminates a liquid contained in the plastic item. Plastic additives and/or fragments are leached out because they dissolve in polar protic or polar aprotic solvents in particular. However, it is precisely these solvents that are generally used in the life science sector. Non-polar solvents, which would leach out non-polar components from the plastic, such as oligomers, are practically not used in the life science sector. There is therefore a need for plastics that do not leach plastic additives and/or fragments out of the plastic, particularly in these areas of application.

One way of preventing the leaching of undesirable components from the plastic is to omit the plastic additives. However, this regularly has the problem that the thermal stability of the plastics is then reduced, so that these can no longer be thermally processed and thermally decompose. The thermal processability of plastics can be completely lost.

Another way of preventing additives from being leached from the plastic is to apply one or more layers to the inside of a plastic item in which a liquid sample is to be stored and tested, for example. These layers are, for example, SiOx layers, which are intended to provide a barrier against leaching from the plastic material. However, in most cases it has been found that the one or more SiOx layers on the plastics have inadequate barrier properties, and in some cases soluble components are even leached out of the barrier layers themselves in an undesirable manner and pass into the contained liquid sample. A further disadvantage of these layers is the risk that the coating can become detached, e.g. during the treatment of a liquid sample, especially when using ultrasound, and then contaminate the contained sample.

Furthermore, the additional production step of coating the plastic item increases the production costs considerably, which is very disadvantageous from an economic point of view.

From the publication: Macromolecules, 2016, 49 (17), pp. 6497-6506, for example, poly(cyclohexylethylene-ran-ethylene) copolymers (CE) have become known whose statistical segment lengths have been synthesized in such a way that they correspond to those of isotactic poly(propylene) (iPP). These plastics do not appear to contain any additives. Films, but not containers, have been produced from these plastics.

There is therefore great interest and a great need for plastic items that avoid the disadvantages of the prior art and, in particular, have no or practically no components that can be leached from the plastic and yet the plastic is thermally stable and can be processed in the usual way.

### DETAILED DESCRIPTION OF THE INVENTION

The task described above is solved according to the invention by an injection-molded disposable plastic item consisting of the two plastics low-density polyethylene (LDPE) and cyclic block copolymer (CBC), wherein 95-30 wt. % by weight of LDPE and 5-70% by weight of CBC are present, the injection-molded disposable plastic item is translucent or transparent, has a melt flow index MFR (190° C./2.16 kg) in the range from 0.1 to 2.5 g/10 min according to ISO 1133 and contains no additives.

Preferred mixing ratios of low-density polyethylene (LDPE) to cyclic block copolymer (CBC) are in the range of 9:1 to 1:1.

In the following, low-density polyethylene is referred to as LDPE and cyclic block copolymer as CBC for the sake of simplicity.

The term “disposable item” is used here to refer to an item that is intended for single use only and is then disposed of. The disposable item here is a disposable plastic item, i.e. it is made of plastic. Other components apart from the two plastics should not be present.

The term “injection-molded disposable plastic item” refers to a disposable item made of plastic that is produced using an injection molding process and is only available through this process. Injection molding is a forming process for plastic known to the skilled person, in which the plastic is liquefied in an injection molding device and is injected into a mold, the injection mold, under pressure. The liquefied plastic solidifies in the mold through cooling or a cross-linking reaction, wherein the cavity of the mold, the so-called cavity, determines the shape and structure of the molded part. After solidification, the mold is opened and the molded part produced is removed. In the present invention, no crosslinking reaction takes place, since no reactive groups, such as double bonds, are present in the two plastics.

In the following, the injection-molded disposable plastic item is also referred to simply as a disposable plastic item or plastic item.

The first plastic contained in the disposable plastic item is selected from the class of LDPEs. In LDPE, “LD” stands for “low density” and “PE” for polyethylene. It is a polyethylene of low-density, also known as low-density polyethylene (PE-LD). It is a thermoplastic plastic material. The polyethylene in LDPE is present in highly branched polymer chains, resulting in a low density in the range of 0.915 g/cm³ to 0.935 g/cm⁽³⁾ (according to ISO 1183 or ASTM D1505, which are equivalent).

LDPE or low-density polyethylene is soft and not very heat-resistant, but very impact-resistant. According to the invention, LPDEs are used that are free of additives. For example, LDPEs for medical and pharmaceutical use (medical-grade) that are free of additives are commercially available. LDPEs are used that are transparent or translucent and can be injection molded. An LDPE is injection moldable if it has a melt flow index MFR according to ISO 1133 (MFR/190/2.16: test temperature 190° C., mass 2.16 kg), which is in the range of 0.1 to 2.5 g/10 min. An LDPE the MFR of which is in the specified range is therefore selected.

Exemplary commercial products for LDPE that can be used according to the invention are the products of the Borealis Group and the Sabic Group, such as Bormed™ LE6600-PH, a trademark of the Borealis Group, an additive-free LDPE with an MFR (190° C./2.16 kg) of 1.5 g/10 min according to ISO 1133 or SABIC LDPE PCG09 an additive-free LDPE with an MFR (190° C./2.16 kg) of 7.5 dg/min (=0.75 g/min) according to ISO 1133, or SABIC LDPE PCG22 an additive-free LDPE with an MFR (190° C./2.16 kg) of 22 dg/min (=2.2 g/min) according to ISO 1133.

The second plastic contained in the disposable plastic item is selected from the class of cyclic block copolymers (CBC) and is also a thermoplastic. This is a class of relatively new plastics from USI Corp. that are also available additive-free. Cyclic block copolymers (CBCs) are fully hydrogenated polymers based on styrene and conjugated dienes obtained by anionic polymerization. The hydrogenation of styrene-butadiene block copolymers to form CBCs is carried out, for example, according to the following scheme:

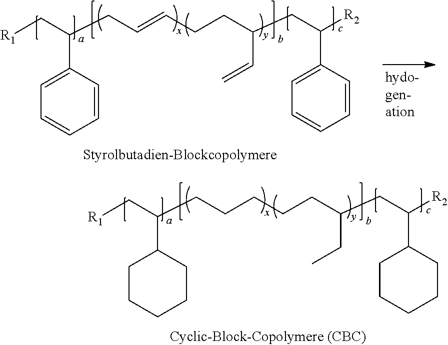

The remainders R1, R2 and the parameters a, b, x and y can be selected in a suitable manner. No information on this is available in the prior art.

The properties of the CBCs can be adjusted over a wide range by adjusting the ratio of cyclohexylethylene (CHE) to ethylene-co-1-butene (EB) in the copolymer.

In general, CBC has a high rigidity and a significantly higher heat resistance than LDPE, but is brittle and difficult to process by injection molding. According to the invention, CBCs are used that are free of additives. For example, CBCs for medical and pharmaceutical use (medical-grade) that do not contain any additives are commercially available. According to the invention, CBCs are used that are transparent and can be injection molded. A CBC is injection-moldable if it has a melt flow index MFR according to ISO 1133 (MFR/190/2.16: test temperature 190° C., mass 2.16 kg) which is in the range from 0.1 to 2.5 g/10 min. A CBC is therefore selected the MFR of which lies within the specified range.

The known types of CBC from USI Corporation, which are known under the trade names ViviOn™Cyclic Block Copolymers (CBC), should be mentioned as exemplary commercial products. These are, for example, ViviOn™CBC 8210, ViviOn™CBC 8210XT, ViviOn™CBC 1325, ViviOn™CBC 1325EUT, ViviOn™CBC 0510HSE, ViviOn™CBC 0510, ViviOn™CBC 0510HF, ViviOn™CBC 0510T, ViviOn™CBC 0510HT, ViviOn™CBC 0510HFP, ViviOn™CBC 0510HFE and ViviOn™CBC 0510FEP. The latest type ViviOn™CBC 0510 HSE is particularly impact-resistant and has a particularly high flowability. For example, these CBCs have a transmission (380-760 nm) of at least 91% according to ASTM D1003. These CBCs all have, for example, an MFR (260° C./2.16) in the range from 5 to 13 g/10 min or an MFR (190° C., 2.16) of 1 to 3 cm³/min (=1 to 3 g/min) in each case according to ASTM D1238 (which is equivalent to ISO 1133). The specified CBCs are therefore all injection moldable.

Surprisingly, it has now been found that the properties of LDPE and CBC can be combined with each other, resulting in particularly advantageous properties for the plastic item made from them.

Due to its composition, the injection-molded disposable plastic item has the special feature that components that can be leached out of it by solvents are reduced to an unavoidable proportion, i.e. to a minimum. “Reduced to a minimum” in this context means reduced to a minimum proportion or a minimum of solvent-leachable components that cannot be avoided. This applies in particular to polar protic or polar aprotic solvents. Polar aprotic solvents are, for example, ketones, such as acetone, lactones, lactams, nitro compounds, such as nitromethane, tertiary carboxylic acid compounds, such as dimethylformamide, ureas, sulphoxides, such as dimethyl sulphoxide, sulphones and carbonic acid esters, such as ethylene carbonate. Polar protic solvents are, for example, water, short-chain alcohols such as methanol and ethanol, primary and secondary amines, primary and secondary amides, carboxylic acids and mineral acids. Subsequent sealing and/or coating of the surface of the plastic items is therefore generally not necessary.

The expression “except for an unavoidable proportion” of leached components means that components are always leached out of a plastic; this cannot be completely prevented. However, the proportion of components leached from the plastic is so small that it is usually even below the detection limit and can be ignored. Contamination of the liquid content of the disposable plastic item has not been observed to date. In other words, the injection-molded disposable plastic item can also be used in areas where very high quality requirements are placed on the plastic, such as the life science sector, without contamination of the contents by leached plastic components.

The plastic item is also inert to solvents, in particular polar protic or polar aprotic solvents. The term “inert to solvents” is understood here to mean that the plastic item remains unchanged even after prolonged contact with a solvent or a mixture of solvents, i.e. its chemical composition is not changed. In addition, as already explained, practically no component is leached out of the plastic item by the solvent or solvents.

Furthermore, the disposable plastic item is translucent or even transparent due to the plastics used. “Translucency” is understood here to mean that there is partial translucency, so that the plastic item is translucent, similar to frosted glass, but not transparent. The plastic item is then only partially translucent and not transparent, but diaphanous, which can also be described as opaque.

“Transparency” means that the plastic item is see-through. The term “transparent” refers to materials that allow the majority of light to pass through, with a small amount of light being absorbed and scattered. Transparency is therefore the ability of matter to allow light waves to pass through (transmission). Transparent materials are characterized by high degrees of transmission. The term “transparent” here means that the disposable plastic item has a high light transmission of at least 75% or at least 80% or at least 85% or at least 90% or at least 95% of the light of the wavelength and thickness of the material used. For example, the opacity and light transmission of transparent plastics is determined at 380 to 760 nm in accordance with ASTM D1003, whereby the values specified above are obtained.

In the injection-molded disposable plastic item according to the invention, transparency is only achieved because no phase boundaries occur in the mixing ratios of the two components low-density polyethylene (LDPE) and cyclic block copolymer (CBC). The two plastics are particularly easy to mix. Phase boundaries when mixing different materials would lead to difficulties and would be visually detrimental to transparency, but would also result in mechanical weaknesses. Surprisingly, this is not the case with the disposable plastic item according to the invention.

Both transparent and translucent plastic items are particularly advantageous, as the contents of the plastic item can be seen from the outside. This is useful, for example, when inspecting samples in the plastic item.

Whether a transparent or translucent disposable plastic item is obtained depends on the selected mixing ratio of the two components used: low-density polyethylene (LDPE) and cyclic block copolymer (CBC): LDPE in itself, for example, is usually translucent. CBC itself is transparent or even highly transparent. Surprisingly, the transparency or translucency is not lost in the disposable articles, so that the optical properties of LDPE and CBC can be combined and the contents of the plastic item can be seen from the outside or even be seen explicitly. The more CBC is contained in the disposable plastic item, the more the resulting plastic item changes from translucent to transparent.

Mixing the two plastics gives the injection-molded disposable plastic item improved overall injection molding properties, so that disposable plastic items can be produced by injection molding. The disposable plastic item has a melt flow index MFR (1900° C./2.16 kg) in the range of 0.1 to 2.5 g/10 min according to ISO 1133 or ASTM D1238. ISO 1133 and ASTM D1238 are considered technically equivalent, so that the MFR values obtained are the same. The flow behavior of a thermoplastic and thus its degree of polymerization can be determined via the melt flow index MFR. This therefore accounts for the good injection molding behavior of the plastic item of the invention.

The selected CBC/LDPE blends are therefore suitable for the production of disposable plastic items that can be produced in a single production step, for example. The disposable plastic items can therefore be produced cost-effectively.

The shapes of the disposable plastic items are not further limited; they can be any shape known to the person skilled in the art. These are, for example, caps of containers, closures of containers, packaging, in particular in the form of containers, microtest plates (deepwell plates), containers, in particular sample containers, such as bottles or flasks, vials, sample tubes, cuvettes (i.e. sample containers with plane-parallel side surfaces) for optical examinations (e.g. UV/VIS) of liquids, containers with closures, in particular wherein the closure and the container are inseparably connected to each other, i.e. in one piece, pipette tips, syringes or infusion containers.

However, the disposable plastic item should not be in the form of a film.

Depending on how the disposable items are shaped, they have different requirement and property profiles. For example, the requirements for a pipette tip would be that it is straight and has no distortion, whereas in the case of a container, for example, stability plays a role, e.g. during centrifugation. These requirements and properties can easily be provided according to the invention.

Thus, by adjusting the ratio of the two plastics, it is possible to specifically adjust the thermal and mechanical properties of the plastic item of the invention and even to adapt or “tune” it for certain property profiles. While LPDE is not as thermally stable and very soft and is therefore very limited when used on its own, CBC is very stiff, but would be too stiff or too brittle as the sole component in some cases. The combination of both plastics therefore has the great advantage that a variety of property profiles are available, which can be specifically matched to the intended purpose and application. In addition, the disposable plastic item is unexpectedly translucent to transparent and additive-free.

The term “additive-free” means that the plastic item does not contain any additives of any kind that were added for or during production and that the plastics used as starting materials in the form of LDPE and CBC are also used without additives.

The possible uses for the disposable item are also not limited; every possible use for a plastic item is possible for a person skilled in the art. The intended use is therefore very diverse and can comprise, for example, storage, sampling, sample processing, in particular carrying out tests with samples and the like.

Containers in which the sample concentration is very low are particularly advantageous, as the advantageous properties of the present invention then come into play particularly well. For example, a pipette tip as a disposable plastic item is particularly advantageous, since the plastic prevents contamination of a contained sample by leached components (except for unavoidable minimum proportions).

The disposable plastic items are preferably used in areas that deal with living organisms, their structures and processes, particularly preferably in all steps that are carried out in the laboratory. These are, for example, the fields of medicine, pharmacology, biochemistry, biotechnology, in particular cell biology, microbiology or molecular biology. Particularly preferred uses are in the storage of pharmaceuticals, the cultivation of cells, in the performance of biological or medical tests, in all process steps in a molecular biology laboratory, such as the handling, duplication and storage of biomolecules such as DNA, RNA or proteins.

Furthermore, the present invention relates to a method for the production of an injection-molded disposable plastic item according to the invention with the following steps:
a. dry mixing of the granules of low-density polyethylene (LDPE) and cyclic block copolymer (CBC), which are each used additive-free, wherein a low-density polyethylene (LDPE) is used which is translucent or transparent and has a melt flow index MFR (190° C./2.16 kg) in the range from 0.1 to 2.5 g/10 min according to ISO 1133 and a cyclic block copolymer (CBC) is used which is transparent and has a melt flow rate index MFR (190° C./2.16 kg) in the range from 0.1 to 2.5 g/10 min according to ISO 1133 and 95-30 wt. % low-density polyethylene (LDPE) and 5-70 wt. % cyclic block copolymer (CBC) are used and no plastic additive is added and
b. injection molding of the resulting mixture to obtain a disposable injection molded plastic item in the desired shape.

The production is basically a dry-blend process. Only the granules are mechanically mixed together and injection molding takes place immediately afterwards. It is preferable if no extrusion is carried out before injection molding.

A particular advantage of the method is that it is basically possible to use injection molds, which are normally used for injection molding of polypropylene, directly for the production of the corresponding plastic items according to the invention. This greatly simplifies the method and is particularly economical.

It is also an object of the invention to use the injection-molded disposable plastic item according to the invention in medicine, pharmacology, biochemistry, biotechnology, in particular cell biology, microbiology or molecular biology, for storage, sampling, sample processing, performance of tests, in particular of liquid-containing ingredient(s), preferably in the presence of polar protic or polar aprotic solvents.

The term “ingredient(s)” means any form of one or more ingredients that are present in the injection-molded disposable plastic item according to the invention, for example, that are to be stored in the article and possibly processed further. For example, a sample container in which a sample is located.

The expression “liquid-containing ingredient(s)” means that the ingredient(s) is (are) at least partially present together with a liquid or a mixture of liquids in the injection-molded disposable plastic item according to the invention. Any combination of ingredient(s) and liquid(s) is conceivable. This can be, for example, a solution, suspension, emulsion or dispersion.

The advantages of the invention are extremely complex:

Two classes of plastic are used, selected from low-density polyethylene (LDPE) and cyclic block copolymer (CBC), which do not contain plastic additives, from which a disposable plastic item is produced by injection molding. Production can therefore be carried out in a simple manner, with the possibility of using injection molds that are used for injection molding of polypropylene. This is particularly advantageous, as no separate injection molds need to be produced.

The disposable plastic item is translucent or transparent, which is advantageous because the ingredient(s) is/are visible. This can play a role, for example, when viewing or checking the ingredients, e.g. as part of quality control, or when taking and examining samples, e.g. when carrying out tests using an optical method.

The disposable plastic item has a melt flow index MFR (190° C./2.16 kg) in the range of 0.1 to 2.5 g/10 min according to ISO 1133 and is therefore particularly good and easy to produce by injection molding. The injection-molded disposable plastic item is given improved overall injection molding properties by mixing the two plastics. The selected CBC/LDPE blends are therefore suitable for the production of disposable plastic items in a single production step. The disposable plastic items can therefore be produced cost-effectively.

There are also no additives in the disposable plastic item.

Preferred mixing ratios of low-density polyethylene (LDPE) to cyclic block copolymer (CBC) are in the range of 9:1 to 1:1. The two plastics mix unexpectedly well and no phase boundaries are observed during mixing. By adjusting the mixing ratio, different requirement and property profiles can be specifically set for disposable plastic items.

The injection-molded disposable plastic item also has the particularly advantageous property that components that can be leached out of it by solvents are reduced to a minimum, except for an unavoidable proportion. This is particularly true when polar protic or polar aprotic solvents are used.

It is also possible to subject the disposable plastic item to a hydrogen plasma treatment. This not only causes sterilization, but also a chemical functionalization of the plastic surface. This gives the disposable plastic item molecule-repellent, in particular biomolecule-repellent properties, which prevents non-specific adsorption of liquid ingredients on the walls of the disposable plastic item that are in contact with the liquid ingredients. The ingredient thus remains largely unchanged on contact with the disposable plastic item.

The shape of the disposable plastic item is not further limited if it is injection molded, so a variety of shapes are possible for a wide range of uses.

### EMBODIMENT EXAMPLES

### Examples 1 to 6

In the following, an injection molding process for the production of the injection-molded disposable plastic item according to one embodiment of the invention is explained in detail:

The plastics used were Bormed™ LE6600-PH, a low-density polyethylene (LDPE) from the Borealis Group, and ViviOn™CBC 0510HFE, a cyclic block copolymer (CBC) from USI Corp.

A 2-cavity full hot runner mold was used as the injection mold. The plastics were used as granulates in the following mixtures:

TABLE 1

| Ex- | | | Mixing |
|---|---|---|---|
| ample | LDPE | CBC | ratio |
| 1 | Bormed ™ LE6600-PH | ViviOn ™CBC 0510HFE | 90:10 |
| 2 | Bormed ™ LE6600-PH | ViviOn ™CBC 0510HFE | 85:15 |
| 3 | Bormed ™ LE6600-PH | ViviOn ™CBC 0510HFE | 80:20 |
| 4 | Bormed ™ LE6600-PH | ViviOn ™CBC 0510HFE | 70:30 |
| 5 | Bormed ™ LE6600-PH | ViviOn ™CBC 0510HFE | 60:40 |
| 6 | Bormed ™ LE6600-PH | ViviOn ™CBC 0510HFE | 50:50 |

The injection molding parameters were as follows:
Screw diameter: 20 cm
Ground temperature: 235-260° C.
Mold temperature 30° C.
Cooling time: 4 s
Injection pressure: approx. 1000 bar
Cycle time: 8 s

The injection pressure increased with the addition of ViviOn™CBC 0510HFE, for example by 150 bar at a proportion of 50%.

After cooling, the mold was opened and the injection-molded disposable plastic item could be removed. In the examples, these were containers. These were translucent in examples 1 and 2 and transparent in examples 3 to 6. The melt flow index MFR (190° C./2.16 kg) for the injection-molded disposable plastic items in examples 1 to 6 was in the range of 0.1 to 2.5 g/10 min according to ISO 1133.

### Example 7

### Centrifugation Test:

Using the plastic compositions shown in table 1, disposable plastic items in the form of centrifuge tubes with lids with a capacity of 1.5 mL were produced using the injection molding method described in examples 1 to 6. The lid was firmly attached to the centrifuge tube with a small band, so that a one-piece disposable plastic item was available.

A saturated NaCl solution was added to the centrifugation tubes, the lid was closed and the centrifugation tubes were tested in an Eppendorf centrifuge C5430 Research at 4° C. and 25° C. for 90 minutes.

The maximum centrifugability was:
25000 g at 4° C.
20000 g at 25° C.

The centrifugation tubes can therefore also be used for high g-values.

The centrifugation test therefore confirms that the disposable plastic items can tolerate the load under high g-values and show no adverse effects on the material.

### Example 8

### Vapor Tightness Test:

With the plastic compositions of examples 3, 4 and 6 given in Table 1, disposable plastic items in the form of centrifuge tubes with lids with a capacity of 1.5 mL were produced using an injection molding method as described in examples 1 to 6 and filled into 6 tubes each of ethanol/water (1:1), closed with the lid and then stored at 70° C. for 1 hour. The vessels were weighed at the beginning and at the end of the test. A vessel is considered vapor-tight and according to specification (“in spec”) if the difference between them is less than 0.2%.

The results of the vapor tightness test were as follows:

TABLE 2

| | | | Mixing | |
|---|---|---|---|---|
| Example | LDPE | CBC | ratio | Result |
| 3 | Bormed ™ | ViviOn ™CBC | 80:20 | 5/6 in spec |
| | LE6600-PH | 0510HFE | | |
| 4 | Bormed ™ | ViviOn ™MCBC | 70:30 | 5/6 in spec |
| | LE6600-PH | 0510HFE | | |
| 6 | Bormed ™ | ViviOn ™CBC | 50:50 | 6/6 in spec |
| | LE6600-PH | 0510HFE | | |

The results show that always 6 identical vessels were tested, 5 of which were in the specification, i.e. tight.

1. Injection-molded disposable plastic item comprising: two plastics, low-density polyethylene (LDPE) and cyclic block copolymer (CBC), wherein 95-30 wt. % LDPE and 5-70 wt. % CBC are present, the injection-molded disposable plastic item is translucent or transparent, has a melt flow index MFR (190° C./2.16 kg) in the range from 0.1 to 2.5 g/10 min according to ISO 1133, and contains no additives.

2. Injection-molded disposable plastic item according to claim 1, wherein
the mixing ratio of low-density polyethylene (LDPE) to cyclic block copolymer (CBC) is in the range of 9:1 to 1:1.

3. Injection-molded disposable plastic item according to claim 1, wherein
components in the disposable plastic item that can be leached out by solvents are reduced to a minimum except for unavoidable proportions.

4. Injection-molded disposable plastic item according to claim 3, wherein
the solvent or solvents are a polar protic or polar aprotic solvent or a mixture thereof.

5. Injection-molded disposable plastic item according to claim 4, wherein
the polar aprotic solvent is selected from ketones, such as acetone, lactones, lactams, nitro compounds, such as nitromethane, tertiary carboxylic acid compounds, such as dimethylformamide, ureas, sulfoxides, such as dimethylsulfoxide, sulfones or carbonic acid esters, such as ethylene carbonate, or mixtures thereof, and
the polar protic solvent is selected from water, short-chain alcohols such as methanol and ethanol, primary and secondary amines, primary and secondary amides, carboxylic acids, mineral acids and mixtures thereof.

6. Injection-molded disposable plastic item according to claim 1, wherein
the latter is in the form of a cap of a container, a closure of a container, a package, in particular in the form of a container, a microtest plate, a container for liquids, in particular a sample container, such as a bottle or a flask, a vial, a sample tube, a cuvette for optical examinations of liquids, a container with a closure, in particular wherein the closure and the container are inseparably connected to one another, a pipette tip, a syringe or an infusion container.

7. Method for the production of an injection molded disposable plastic item according to claim 1 comprising the following steps:
dry mixing of the granules of low-density polyethylene (LDPE) and cyclic block copolymer (CBC), which are each used additive-free,
wherein a low-density polyethylene (LDPE) is used which is translucent or transparent and has a melt flow index MFR (190° C./2.16 kg) in the range from 0.1 to 2.5 g/10 min according to ISO 1133 and
a cyclic block copolymer (CBC) is used which is transparent and has a melt flow rate index MFR (190° C./2.16 kg) in the range from 0.1 to 2.5 g/10 min according to ISO 1133 and
95-30% by weight low-density polyethylene (LDPE) and 5-70% by weight cyclic block copolymer (CBC) are used, and no plastic additive is added, and
injection molding of the resulting mixture to obtain a disposable injection molded plastic item in the desired shape.

8. Method according to claim 7, wherein
injection molds used for the injection molding of polypropylene are used.

9. Use of the injection-molded disposable plastic item according to claim 1 in medicine, pharmacology, biochemistry, biotechnology, in particular cell biology, microbiology or molecular biology, for storage, sampling, sample processing, carrying out tests, in particular of liquid-containing ingredients, preferably in the presence of polar protic or polar aprotic solvents.
